(19) United States
(12) Patent Application Publication
(10) Pub. No.: US 2024/0425074 A1
(43) Pub. Date: Dec. 26, 2024

(54) PATH PREDICTION IN AUTONOMOUS DRIVING SYSTEM

(71) Applicant: GM GLOBAL TECHNOLOGY OPERATIONS LLC, Detroit, MI (US)

(72) Inventors: Mohammadali Shahriari, Markham (CA); Mehdi Abroshan, Waterloo (CA); Amanpal S Grewal, Novi, MI (US); Dmitriy Feldman, W Bloomfield, MI (US); Robert C Baraszu, Livonia, MI (US)

(73) Assignee: GM GLOBAL TECHNOLOGY OPERATIONS LLC, Detroit, MI (US)

(21) Appl. No.: 18/341,328

(22) Filed: Jun. 26, 2023

(51) Int. Cl. B60W 60/00; B60W 40/02

(52) U.S. Cl. CPC B60W 60/001; B60W 40/02; B60W 2520/06; B60W 2554/404

(57) ABSTRACT

Methods and systems for providing driving assistance in a vehicle. In one embodiment, a method includes: receiving, by a processor, vehicle data from a sensor system of the vehicle; determining, by a processor, a path of the vehicle based on the steering data; expanding, by the processor, the path of the vehicle to a path area based on probabilistic uncertainty bound prediction; determining, by the processor, a target object based on the path area and object data that identifies objects within the environment of the vehicle; and generating, by the processor, control signals to vehicle actuators to control the vehicle based on the target object.

### INTRODUCTION

The technical field generally relates to systems, methods, and apparatuses for providing path prediction of an autonomous or semi-autonomous driving system.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Some autonomous driving features allow for adaptive cruise control and lane following where speed and/or steering is controlled to follow an intended path or an intended lane. These features use target tracking to track objects within the path or lane. In order to effectively detect and select targets, a vehicle path prediction is performed. However, there are uncertainties associated with a vehicle path along the prediction horizon, which includes vehicle dynamics projection error, actuation, and environmental uncertainties.

Accordingly, it is desirable to provide improved path planning strategies, methods, and systems for improved target tracking used in follow mode and adaptive cruise control operations as well as for other obstacle detection. Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicles with, methods for, and systems for driving assistance. In one embodiment, a method includes: a method for providing driving assistance in a vehicle, comprising: receiving, by a processor, vehicle data from a sensor system of the vehicle; determining, by a processor, a path of the vehicle based on the vehicle data; expanding, by the processor, the path of the vehicle to a path area based on probabilistic uncertainty bound prediction; determining, by the processor, a target object based on the path area and object data that identifies objects within the environment of the vehicle; and generating, by the processor, control signals to vehicle actuators to control the vehicle based on the target object.

In various embodiments, the method includes: determining a steering maneuver based on the vehicle data; determining a vehicle model based on the steering maneuver; and wherein the determining the path of the vehicle is based on the vehicle model.

In various embodiments, the steering maneuver includes at least one of a cornering maneuver, a turn maneuver, a swerve maneuver, and a straight maneuver.

In various embodiments, the method includes: adapting the vehicle model based on feedback data associated with an actual vehicle path.

In various embodiments, the path includes a plurality of points, and wherein expanding includes using the probabilistic uncertainty bound prediction to determine a width perpendicular to the path at each point of the plurality of points, wherein the width is associated with at least one uncertainty.

In various embodiments, the at least one uncertainty includes measurement noises.

In various embodiments, the at least one uncertainty includes steering angle rate.

In various embodiments, the method includes identifying at least one obstacle based on the path area and the object data that identifies objects within the environment of the vehicle.

In another embodiment, a system includes: a controller configured to, by a processor: receive vehicle data from a sensor system of the vehicle; determine a path of the vehicle based on the vehicle data; expand the path of the vehicle to a path area based on probabilistic uncertainty bound prediction; determine a target object based on the path area and object data that identifies objects within the environment of the vehicle; and generate control signals to vehicle actuators to control the vehicle based on the target object.

In various embodiments, the controller is further configured to: determine a steering maneuver based on the vehicle data; determine a vehicle model based on the steering maneuver; and wherein the controller determines the path of the vehicle based on the vehicle model.

In various embodiments, the steering maneuver includes at least one of a cornering maneuver, a turn maneuver, a swerve maneuver, and a straight maneuver.

In various embodiments, the controller is further configured to adapt the vehicle model based on feedback data associated with an actual vehicle path.

In various embodiments, the path comprises a plurality of points, and wherein controller is configured to expand the path using the probabilistic uncertainty bound prediction to determine a width perpendicular to the path at each point of the plurality of points, wherein the width is associated with at least one uncertainty.

In various embodiments, the at least one uncertainty includes measurement noises.

In various embodiments, the at least one uncertainty includes steering angle rate.

In various embodiments, the controller is further configured to identify at least one obstacle based on the path area and the object data that identifies objects within the environment of the vehicle.

In another embodiment, a vehicle includes: a sensor system associated with a steering system; an actuator system; a human machine interface (HMI); and a controller for implementing a driver assistance system, the controller configured to: receive vehicle data from the sensor system; determine a path of the vehicle based on the vehicle data; expand the path of the vehicle to a path area based on probabilistic uncertainty bound prediction; determine a target object based on the path area and object data that identifies objects within the environment of the vehicle; and generate control signals to the actuator system to control the vehicle based on the target object.

In various embodiments, the path includes a plurality of points, and wherein controller is configured to expand the path using the probabilistic uncertainty bound prediction to determine a width perpendicular to the path at each point of the plurality of points, wherein the width is associated with at least one uncertainty.

In various embodiments, the at least one uncertainty includes measurement noises.

In various embodiments, the at least one uncertainty includes steering angle rate.

### BRIEF DESCRIPTION OF THE DRAWINGS

The exemplary embodiments will hereinafter be described in conjunction with the following drawing figures, wherein like numerals denote like elements, and wherein:

FIG. 1 is a block diagram illustrating an autonomous vehicle having follow mode path prediction system, in accordance with various embodiments;

FIG. 2 is a functional block diagram illustrating features of an autonomous driving system of the autonomous vehicle, in accordance with various embodiments;

FIG. 3 is a dataflow diagram illustrating features of the follow mode path prediction system of the autonomous driving system, in accordance with various embodiments;

FIG. 4 is an illustration of path prediction as performed by the follow mode path prediction system, in accordance with various embodiments; and

FIG. 5 is a process flow chart depicting example processes for path prediction, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein are merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

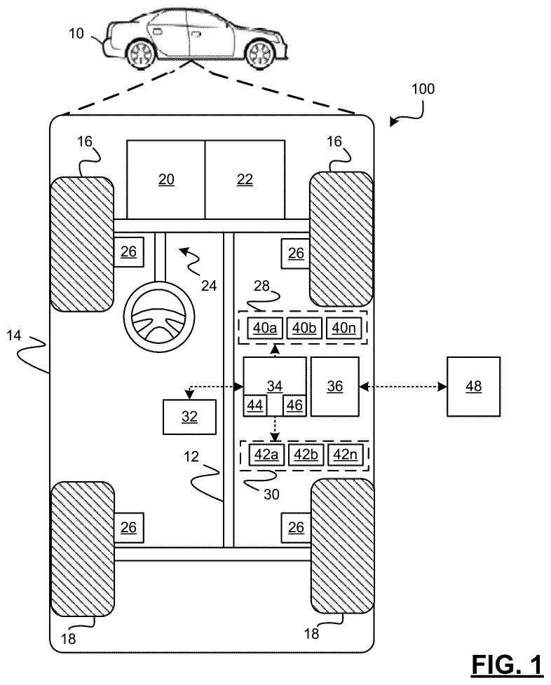

With reference to FIG. 1, a follow mode path prediction system shown generally at 100 is associated with a vehicle 10 in accordance with various embodiments. In general, the path prediction system 100 predicts a path that the vehicle 10 will be following. The predicted path may be used in detecting and selecting targets to be followed and/or avoided according to a follow mode. In general, the path prediction system 100 predicts the path based on a probabilistic model uncertainty bound that formulates uncertainties associated with vehicle path prediction including, but not limited to, vehicle dynamics projection error, and actuation and environmental uncertainties. This improved path prediction provides for more robust follow mode type operations such as used in adaptive cruise control and lane following and other autonomous or semi-autonomous control features.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the path prediction system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is configured to perform autonomous features such as, but not limited to, adaptive cruise control, super cruise, ultra-cruise, etc.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

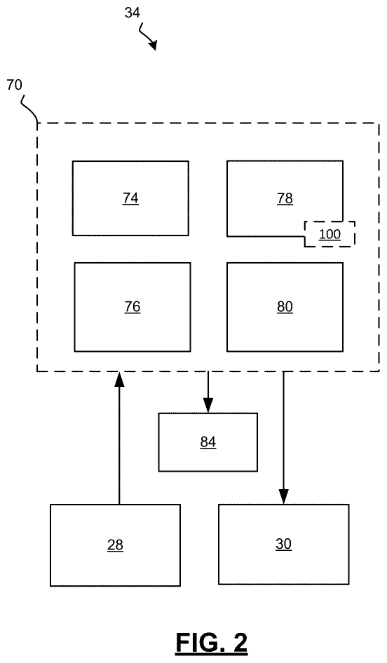

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system. For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, as discussed in detail below, one or more instructions of the controller 34 are embodied in the path prediction system 100 and, when executed by the processor 44, process sensor data and/or other data, predict a path using probabilistic model uncertainty bounding and use the predicted path to track objects used by a follow mode of an autonomous feature.

Referring now to FIG. 2, and with continued reference to FIG. 1, a dataflow diagram illustrates various embodiments of an autonomous driving system (ADS) 70 which may be embedded within the controller 34 and which may include parts of the path prediction system 100 in accordance with various embodiments. That is, suitable software and/or hardware components of controller 34 (e.g., processor 44 and computer-readable storage device 46) are utilized to provide an autonomous driving system 70 that is used in conjunction with vehicle 10.

Inputs to the autonomous driving system 70 may be received from the sensor system 28, received from other control modules (not shown) associated with the autonomous vehicle 10, received from the communication system 36, and/or determined/modeled by other sub-modules (not shown) within the controller 34. In various embodiments, the instructions of the autonomous driving system 70 may be organized by function or system. For example, as shown in FIG. 2, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to, cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path. In particular, the vehicle control system 80 generates control signals (e.g., steering control signals, acceleration control signals, braking control signals) for the actuator system 30 to direct the vehicle to follow the desired trajectory determined by the guidance system 78.

In various embodiments, the path prediction system 100 may be incorporated into a vehicle following system 82 that interacts with a Human Machine Interface (HMI) 84 to allow a driver of vehicle 10 to select a vehicle tracked by the computer vision system 74 as a lead vehicle for the vehicle 10 to follow. The vehicle following system 82 facilitates the ADS 70 transitioning from an internal navigation route operating mode or an infinite route operating mode to a follow operating mode. The vehicle following system 82 provides status information to a vehicle driver via the HMI 84 regarding implementation of the follow operating mode and provides vehicle tracking data from the computer vision system 74 for use by the guidance system 78 when determining a desired trajectory.

The HMI 84 is available to the ADS 70 for presenting information to the vehicle driver and communicates when a vehicle driver needs to be in control of the vehicle 10. The HMI 84 can be incorporated in a vehicle dashboard and can provide a display of the vehicle environment directly in the driver's line of sight. The HMI 84 can incorporate touchscreen technology for allowing a vehicle driver to enter selections. The HMI 84 can incorporate vehicle speaker systems to provide aural alerts and messages to the vehicle driver.

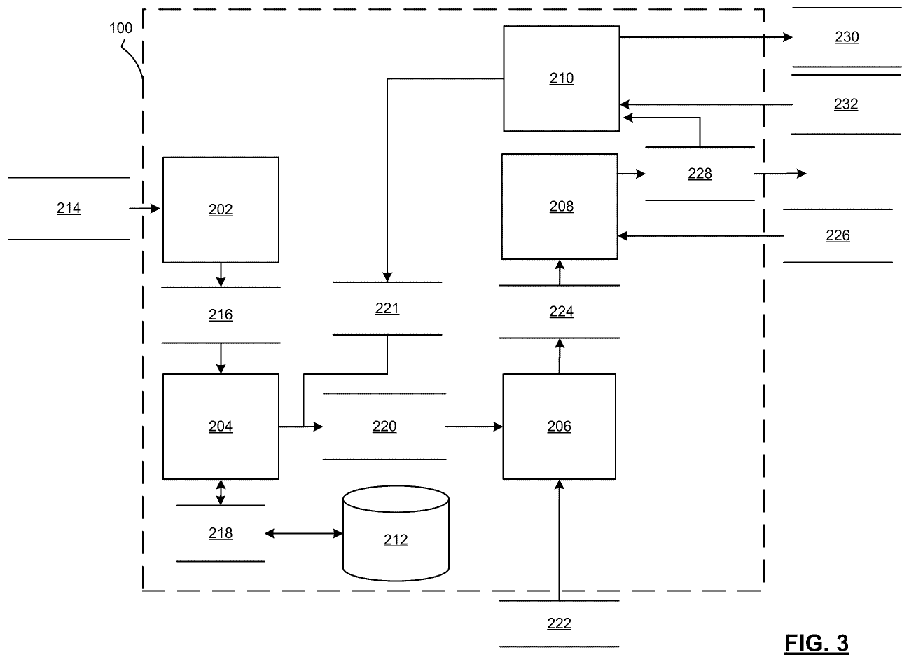

As mentioned briefly above, the path prediction system 100 of FIG. 1 is included within the autonomous driving system 70. For example, all or parts of the path prediction system 100 may be included within or as a part of the guidance system 78. For example, as shown in more detail with regard to FIG. 3 and with continued reference to FIGS. 1 and 2, the path prediction system 100 includes a steering profile module 202, a vehicle model module 204, a vehicle path prediction module 206, a target object prediction module 208, a path following module 210, and a vehicle model datastore 212.

The steering profile module 202 receives as input steering data 214. The steering profile module 202 evaluates the steering data 214 to determine or profile a steering maneuver that is being commanded of the vehicle 10 based on the value and/or the rate of change indicated by the steering data 214. For example, the steering maneuver can include a cornering maneuver, a turn maneuver, a swerve maneuver, a straight maneuver, etc. The steering profile module 202 generates steering maneuver data 216 that indicates the type of the profiled steering maneuver.

The vehicle model module 204 receives as input the steering maneuver data 216. The vehicle model module 204 retrieves a vehicle dynamic model 218 from the vehicle model datastore 212 based on the steering maneuver data 216. For example, any number of vehicle dynamic models are defined for each steering maneuver type and stored in the vehicle model datastore 212; and the vehicle model module 204 retrieves a vehicle dynamic model 218 associated with the current steering maneuver from the vehicle model datastore 212.

In various embodiments, the vehicle model module 204 adapts the retrieved vehicle model 218 based on feedback data 221 obtained from the path following module 210 and generates vehicle model data 220 based thereon. For example, the vehicle model 218 is updated based on whether or not the vehicle 10 previously followed the predicted target object predicted from the vehicle model 218. In various embodiments, the vehicle model module 204 updates the vehicle model 218 based on one or more adaptive learning methods.

The vehicle path prediction module 206 receives as input the vehicle model data 220, and other vehicle data 222. The vehicle path prediction module 206 predicts a vehicle path by processing the steering angle and other vehicle data 222 with the adapted vehicle model from the vehicle model data 220 and using probabilistic uncertainty bound prediction. The vehicle path prediction module 206 generates predicted path area data 224 based thereon.

For example, as shown in FIG. 3, the vehicle path prediction module 206 computes a path 302 of points x at times k 304, 306, 308, etc. using the vehicle dynamic model with no uncertainties as:

$$x ( k + 1 ) = A x ( k ) + B δ ( k ) + \hat{U} . \qquad ( 1 )$$

The uncertainties, such as, but not limited to, transient characteristics of the sensors such as measurement noises and steering angle rate are combined in Û. The steering angle δ includes the front wheels f and the rear wheels r:

$$δ = [ \begin{matrix}{δ}_{f} \\ {δ}_{r}\end{matrix} ] . \qquad ( 2 )$$

The position x includes:

$$x = [ \begin{matrix}β \\ r \\ y \\ ψ\end{matrix} ] , \qquad ( 3 )$$

where β represents sideslip angle, r represents angular velocity or yaw rate, y represents the lateral position, and Ψ represents heading angle as indicated by the vehicle data 222.

The vehicle path prediction module 206 computes then widths 310, 312, 314 by which to expand the vehicle path 302, perpendicularly at each point 304, 306, 308 using probabilistic uncertainty bound prediction to obtain a predicted path area 316 that is, for example, cone in shape. For example, assuming the steering angle remains constant, the width d of the uncertainty area at each time k, is estimated provided the covariance matrix:

$$\sum = [ \begin{matrix}{σ}_{β}^{2} & & & \\ & {σ}_{r}^{2} & & \\ & & {σ}_{y}^{2} & \\ & & & {σ}_{ψ}^{2}\end{matrix} ] , \qquad ( 4 )$$

where σ_{β} represents the standard deviation of side slip angle, σᵣ represents the standard deviation of yaw rate, σ_{y} represents the standard deviation of lateral position, and σ_{ψ}0 represents the standard deviation of vehicle heading. And given the initial covariance matrix:

$${\sum }_{0} = [ \begin{matrix}{σ}_{β 0}^{2} & & & \\ & {σ}_{r 0}^{2} & & 0 \\ & & 0 & \\ & 0 & & 0\end{matrix} ] , \qquad ( 5 )$$

and having the vehicle discretized model, the variance over the horizon can be computed as:

$$\sum ( k + 1 ) = {A}_{d} \sum ( k ) {A}_{d}^{T} + {A}_{d} {\sum }_{0} . \qquad ( 6 )$$

Provided the selected vehicle dynamic model, for example, in equation (1) above, and given that A, B, and U are the matrices of the selected dynamic model, and the third diagonal element of the covariance matrix is the lateral position variance of the predicted vehicle path, the width of the uncertainty area can be computed as:

$$d ( k ) = 2 ( {d}_{0} + G {σ}_{y} ( k ) ) , \qquad ( 7 )$$

where d₀ represents the minimum width, and G represents the tuning gain.

Considering a front wheel steering vehicle and ignoring noise variance of the measurements, one embodiment of the above generalization can be as follows.

The standard deviation of yaw rate r, and sideslip angle β, because of steering angle rate can be expressed as:

$${σ}_{{r}_{0}} = \vert \frac{( {v}_{x}^{k} )}{( {l}_{r} + {k}_{u s} {v}_{x}^{{k}^{2}} )} \vert ( \vert {\dot{δ}}_{f}^{0} \vert {t}_{s} ) , and \qquad ( 8 )$$

$${σ}_{{β}_{0}} = \vert \frac{( ( {C}_{f} {\dot{δ}}_{f}^{0} ) + {r}^{k} ( \frac{{- {l}_{f} {C}_{f} + {l}_{r} {C}_{r}}_{}}{{v}_{x}} - {mv}_{x}^{k} ) )}{{C}_{f} + {C}_{r}} \vert {t}_{s} . \qquad ( 9 )$$

The following is the representation of the linear lateral vehicle dynamic which is used as vehicle path prediction model:

$${x}^{k + 1} = {A}_{d} {x}^{k} + {B}_{d} {δ}_{f}^{0} + {F}_{d} sin ( {θ}_{b} ) \qquad ( 10 )$$

which A_{d}, B_{d}, F_{d} are the discretized matrices of the continuous dynamic model expressed as follows:

$$\dot{x} = Ax + B {δ}_{f}^{0} + F sin ( {θ}_{b} ) \qquad ( 11 )$$

$$A = [ \begin{matrix}\frac{{C}_{f} + {C}_{r}}{{mv}_{x}^{k}} & - \frac{{C}_{f} {l}_{f} - {C}_{r} {l}_{r}}{m} - 1 & 0 & 0 \\ \frac{{C}_{r} {l}_{r} - {C}_{f} {l}_{f}}{{I}_{z}} & - \frac{{C}_{f} {l}_{f}^{2} - {C}_{r} {l}_{r}^{2}}{{I}_{z} {v}_{x}^{k}} & 0 & 0 \\ {v}_{x}^{k} & 0 & 0 & {v}_{x}^{k} \\ 0 & 1 & 0 & 0\end{matrix} ] \qquad ( 12 )$$

$$B = [ \begin{matrix}\frac{{C}_{f}}{{mv}_{x}^{k}} \\ \frac{{C}_{f} {l}_{f}}{{I}_{z}} \\ 0 \\ 0\end{matrix} ] \qquad ( 13 )$$

$$F = [ \begin{matrix}- g \\ 0 \\ 0 \\ 0\end{matrix} ] \qquad ( 14 )$$

$$where$$

$$x = [ \begin{matrix}β \\ r \\ y \\ ψ\end{matrix} ] \qquad ( 15 )$$

And the initial covariance matrix:

$${\sum }_{0} = [ \begin{matrix}{G}_{β} {σ}_{β 0}^{2} & & & \\ & {G}_{r} {σ}_{r 0}^{2} & & 0 \\ & & 0 & \\ & 0 & & 0\end{matrix} ] , \qquad ( 16 )$$

and having the vehicle discretized model, covariance over the horizon can be obtained as:

$${\sum }^{k + 1} = {A}_{d} {\sum }^{k} {A}_{d}^{T} + {A}_{d} {\sum }_{0} , \qquad ( 17 )$$

the third diagonal element of the variance matrix is lateral position variance of the predicted vehicle path:

$${σ}_{y}^{k} = \sqrt{{\sum }^{k} ( 3 , 3 )} . \qquad ( 18 )$$

Then the width of uncertainty area can be obtained as:

$${d}^{k} = 2 ( {d}_{0} + {G}_{σ} {σ}_{y}^{k} ) , \qquad ( 19 )$$

where do and Go are the minimum width and tuning gain, respectively.

At each time, each point of the predicted vehicle path, (xₚ^{k}, yₚ^{k}, ψₚ^{k}), are found follows:

$${β}^{k} = {x}^{k} ( 1 ) , \qquad ( 20 )$$

$${y}_{p}^{k} = {x}^{k} ( 3 ) , \qquad ( 21 )$$

$${ψ}_{p}^{k} = {x}^{k} ( 4 ) , and \qquad ( 22 )$$

$${x}_{p}^{k + 1} = {x}_{p}^{k} + {y}_{x}^{k} cos ( {ψ}_{p}^{k} ) {t}_{s} - {v}_{x}^{k} {β}^{k} sin ( {ψ}_{p}^{k} ) {t}_{s} , \qquad ( 23 )$$

where xₚ^{k} represents longitudinal position, yₚ^{k}, represents lateral position, and ψₚ^{k} represents heading angle of each point of the predicted vehicle path. β^{k} represents side slip angle at time k, r^{k} represents yaw rate at time k, vₓ^{k} represents longitudinal velocity at time k,tₛ represents sampling time, \dot{δ}⁰_{f} represents front steering angle rate at initial time, δ_{f}⁰ represents the front steering angle at an initial time, l_r represents the distance between the front axle and the vehicle center of gravity, l_f represents the distance between the rear axle and the vehicle center of gravity, kᵤₛ represents the understeer coefficient, G_{β} represents the gain for sideslip angle variance, Gᵣ represent the gain for yaw rate variance, g represents the gravitational acceleration, C_{f} represents the front cornering stiffness, Cᵣ represents the rear cornering stiffness, I_{z} represents the vehicle yaw inertia, and m represents the vehicle mass.

As can be appreciated, other dynamic models and uncertainties can be implemented in various embodiments as the disclosure is not limited to the example embodiment provided.

With reference back to FIG. 3, in various embodiments, the target object prediction module 208 receives as input the predicted path area data 224 and object data 226. The object data 226 indicates locations of objects detected within the environment of the vehicle 10. The target object prediction module 208 compares the object data 226 with the predicted path area data 224 to identify objects located within the predicted path area 316. For example, the target object prediction module 208 identifies an object within the uncertainty area as the target object and/or identifies other objects outside of the uncertainty area as obstacles and generates target object data 228 identifying such for use by the path following module 210 and/or other modules or systems of the ADS 70.

The path following module 210 receives as input the target object data 228. The path following module 210 generates path control data 230 based on the location of the object to be followed as identified by the target object data 228 and/or based on the location of the obstacles as identified by the target object data 228. The path control data 230 is then provided to the autonomous driving system 70 to control operation of the vehicle 10 such that the desired path that tracks the target object is achieved.

In various embodiments, the path following module 210 monitors actual path data 232 of the vehicle 10 with respect to the target object data 228. The path following module 210 provides feedback data 221 as to whether or not the controlled path actually followed the identified tracked object or fell off into a different course.

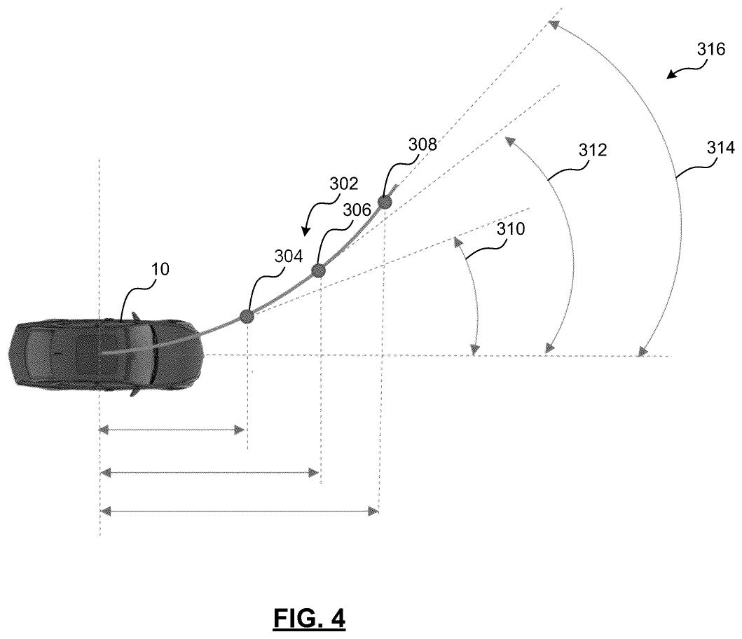

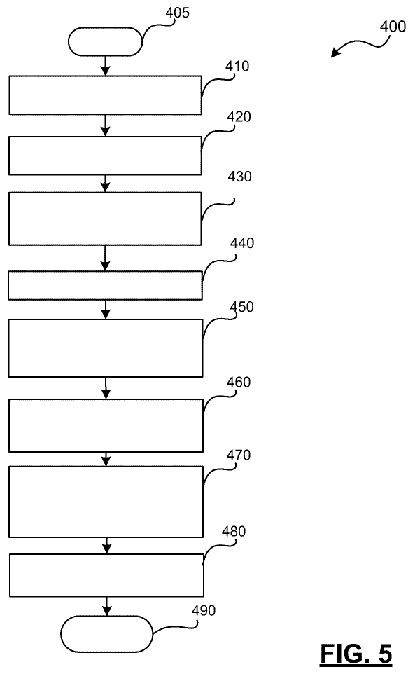

Referring now to FIG. 5, and with continued reference to FIGS. 1-4, a flowchart illustrates a process 400 that can be performed by the path prediction system 100 of FIGS. 1-3 in accordance with the present disclosure. As can be appreciated in light of the disclosure, the order of operation within the process 400 is not limited to the sequential execution as illustrated in FIG. 5 but may be performed in one or more varying orders as applicable and in accordance with the present disclosure. In various embodiments, the process 400 can be scheduled to run based on one or more predetermined events, and/or can run continuously during operation of the autonomous vehicle 10, and/or may be run offline prior to operation of the vehicle 10.

In one example, the process 400 may begin at 405. The steering data 214 is received at 410. The steering data is profiled at 420 to identify the steering maneuver type. The vehicle model is selected and optionally adapted at 430 based on the steering profile type as well as other user inputs. The vehicle path 302 is predicted based on the adapted vehicle model at 440. The vehicle path 302 is expanded using probabilistic uncertainty bound prediction to obtain the vehicle path area 316 as discussed above at 450. Thereafter, the object data 226 is evaluated based on the expanded vehicle path area 316 to identify the target object and/or other objects that may be obstacles at 460. The identified target object and/or obstacles are provided to the follow mode module or system for automated control at 470. Feedback data 221 is collected based on the target object data 228 and the actual path data 232 to be used to subsequently adapt the vehicle model at 480. Thereafter, the process 400 may end at 490.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for providing driving assistance in a vehicle, comprising:
receiving, by a processor, vehicle data from a sensor system of the vehicle;
determining, by a processor, a path of the vehicle based on the vehicle data;
expanding, by the processor, the path of the vehicle to a path area based on probabilistic uncertainty bound prediction;
determining, by the processor, a target object based on the path area and object data that identifies objects within the environment of the vehicle; and
generating, by the processor, control signals to vehicle actuators to control the vehicle based on the target object.

2. The method of claim 1, further comprising:
determining a steering maneuver based on the vehicle data;
determining a vehicle model based on the steering maneuver; and
wherein the determining the path of the vehicle is based on the vehicle model.

3. The method of claim 2, wherein the steering maneuver includes at least one of a cornering maneuver, a turn maneuver, a swerve maneuver, and a straight maneuver.

4. The method of claim 2, further comprising:
adapting the vehicle model based on feedback data associated with an actual vehicle path.

5. The method of claim 1, wherein the path comprises a plurality of points, and wherein expanding comprises using the probabilistic uncertainty bound prediction to determine a width perpendicular to the path at each point of the plurality of points, wherein the width is associated with at least one uncertainty.

6. The method of claim 5, wherein the at least one uncertainty includes measurement noises.

7. The method of claim 5, wherein the at least one uncertainty includes steering angle rate.

8. The method of claim 1, further comprising identifying at least one obstacle based on the path area and the object data that identifies objects within the environment of the vehicle.

9. A system in a vehicle for providing driving assistance, comprising:
a controller configured to, by a processor:
receive vehicle data from a sensor system of the vehicle;
determine a path of the vehicle based on the vehicle data;
expand the path of the vehicle to a path area based on probabilistic uncertainty bound prediction;
determine a target object based on the path area and object data that identifies objects within the environment of the vehicle; and
generate control signals to vehicle actuators to control the vehicle based on the target object.

10. The system of claim 9, wherein the controller is further configured to:
determine a steering maneuver based on the vehicle data;
determine a vehicle model based on the steering maneuver; and
wherein the controller determines the path of the vehicle based on the vehicle model.

11. The system of claim 10, wherein the steering maneuver includes at least one of a cornering maneuver, a turn maneuver, a swerve maneuver, and a straight maneuver.

12. The system of claim 10, wherein the controller is further configured to
adapt the vehicle model based on feedback data associated with an actual vehicle path.

13. The system of claim 9, wherein the path comprises a plurality of points, and wherein controller is configured to expand the path using the probabilistic uncertainty bound prediction to determine a width perpendicular to the path at each point of the plurality of points, wherein the width is associated with at least one uncertainty.

14. The system of claim 13, wherein the at least one uncertainty includes measurement noises.

15. The system of claim 13, wherein the at least one uncertainty includes steering angle rate.

16. The system of claim 9, wherein the controller is further configured to identify at least one obstacle based on the path area and the object data that identifies objects within the environment of the vehicle.

17. A vehicle comprising:
a sensor system associated with a steering system;
an actuator system;
a human machine interface (HMI); and
a controller for implementing a driver assistance system, the controller configured to:
receive vehicle data from the sensor system;
determine a path of the vehicle based on the vehicle data;
expand the path of the vehicle to a path area based on probabilistic uncertainty bound prediction;
determine a target object based on the path area and object data that identifies objects within the environment of the vehicle; and
generate control signals to the actuator system to control the vehicle based on the target object.

18. The vehicle of claim 17, wherein the path comprises a plurality of points, and wherein controller is configured to expand the path using the probabilistic uncertainty bound prediction to determine a width perpendicular to the path at each point of the plurality of points, wherein the width is associated with at least one uncertainty.

19. The vehicle of claim 18, wherein the at least one uncertainty includes measurement noises.

20. The vehicle of claim 18, wherein the at least one uncertainty includes steering angle rate.
